(19) United States
(12) Patent Application Publication
(10) Pub. No.: US 2016/0134402 A1
(43) Pub. Date: May 12, 2016

(54) METHOD AND APPARATUS FOR RECEIVING REFERENCE SIGNAL IN WIRELESS COMMUNICATION SYSTEM

(71) Applicant: LG ELECTRONICS INC., Seoul (KR)

(72) Inventors: Hanjun PARK, Seoul (KR); Hyunho LEE, Seoul (KR); Kijun KIM, Seoul (KR); Hyangsun YOU, Seoul (KR)

(73) Assignee: LG ELECTRONICS INC., Seoul (KR)

(21) Appl. No.: 14/927,155

(22) Filed: Oct. 29, 2015

Related U.S. Application Data
(60) Provisional application No. 62/072,415, filed on Oct. 29, 2014.

(51) Int. Cl. H04L 5/00; H04W 72/04; H04L 27/26

(52) U.S. Cl. CPC H04L 5/0053; H04L 27/2607; H04W 72/042

(57) ABSTRACT

A method for receiving a reference signal for determining a position in a wireless communication system performed by a terminal is provided. The method includes receiving, from a serving base station, cyclic delay information of a plurality of positioning reference signals (PRSs), receiving the plurality of PRSs from a plurality of base stations using the cyclic delay information, each of the plurality of PRSs being repeatedly received a predetermined number of times for a predetermined period of time, and a respective one of the repeatedly received PRSs having different cyclic delay values with an interval, calculating a cross-correlation value of each of the plurality of received PRSs, calculating a time difference of arrival (TDOA) value of each base station based on the cross-correlation value and reporting the calculated TDOA value to the serving base station.

### CROSS-REFERENCE TO RELATED APPLICATIONS

Pursuant to 35 U.S.C. §119(e), this application claims the benefit of U.S. Provisional Patent Application No. 62/072,415, filed on Oct. 29, 2014, the contents of which are hereby incorporated by reference herein in its entirety.

### BACKGROUND OF THE INVENTION

1. Field of the Invention

The present invention relates to a wireless communication system, and more particularly, to a method and apparatus for receiving a reference signal in a wireless communication system.

2. Discussion of the Related Art

Recently, various devices requiring machine-to-machine (M2M) communication and high data transfer rate, such as smartphones or tablet personal computers (PCs), have appeared and come into widespread use. This has rapidly increased the quantity of data which needs to be processed in a cellular network. In order to satisfy such rapidly increasing data throughput, recently, carrier aggregation (CA) technology which efficiently uses more frequency bands, cognitive ratio technology, multiple antenna (MIMO) technology for increasing data capacity in a restricted frequency, multiple-base-station cooperative technology, etc. have been highlighted. In addition, communication environments have evolved such that the density of accessible nodes is increased in the vicinity of a user equipment (UE). Here, the node includes one or more antennas and refers to a fixed point capable of transmitting/receiving radio frequency (RF) signals to/from the user equipment (UE). A communication system including high-density nodes may provide a communication service of higher performance to the UE by cooperation between nodes.

A multi-node coordinated communication scheme in which a plurality of nodes communicates with a user equipment (UE) using the same time-frequency resources has much higher data throughput than legacy communication scheme in which each node operates as an independent base station (BS) to communicate with the UE without cooperation.

A multi-node system performs coordinated communication using a plurality of nodes, each of which operates as a base station or an access point, an antenna, an antenna group, a remote radio head (RRH), and a remote radio unit (RRU). Unlike the conventional centralized antenna system in which antennas are concentrated at a base station (BS), nodes are spaced apart from each other by a predetermined distance or more in the multi-node system. The nodes can be managed by one or more base stations or base station controllers which control operations of the nodes or schedule data transmitted/received through the nodes. Each node is connected to a base station or a base station controller which manages the node through a cable or a dedicated line.

The multi-node system can be considered as a kind of Multiple Input Multiple Output (MIMO) system since dispersed nodes can communicate with a single UE or multiple UEs by simultaneously transmitting/receiving different data streams. However, since the multi-node system transmits signals using the dispersed nodes, a transmission area covered by each antenna is reduced compared to antennas included in the conventional centralized antenna system. Accordingly, transmit power required for each antenna to transmit a signal in the multi-node system can be reduced compared to the conventional centralized antenna system using MIMO. In addition, a transmission distance between an antenna and a UE is reduced to decrease in pathloss and enable rapid data transmission in the multi-node system. This can improve transmission capacity and power efficiency of a cellular system and meet communication performance having relatively uniform quality regardless of UE locations in a cell. Further, the multi-node system reduces signal loss generated during transmission since base station(s) or base station controller(s) connected to a plurality of nodes transmit/receive data in cooperation with each other. When nodes spaced apart by over a predetermined distance perform coordinated communication with a UE, correlation and interference between antennas are reduced. Therefore, a high signal to interference-plus-noise ratio (SINR) can be obtained according to the multi-node coordinated communication scheme.

Owing to the above-mentioned advantages of the multi-node system, the multi-node system is used with or replaces the conventional centralized antenna system to become a new foundation of cellular communication in order to reduce base station cost and backhaul network maintenance cost while extending service coverage and improving channel capacity and SINR in next-generation mobile communication systems.

### SUMMARY OF THE INVENTION

Accordingly, the present invention is directed to a scheme of receiving a reference signal in a wireless communication system and an operation related thereto that substantially obviate one or more problems due to limitations and disadvantages of the related art.

Technical problems to be solved by the present invention are not limited to the above-mentioned technical problems, and other technical problems not mentioned herein may be clearly understood by those skilled in the art from the description below.

To achieve these objects and other advantages and in accordance with the purpose of the invention, as embodied and broadly described herein, a method for receiving a reference signal for determining a position in a wireless communication system performed by a terminal includes receiving, from a serving base station, cyclic delay information of a plurality of positioning reference signals (PRSs), receiving the plurality of PRSs from a plurality of base stations using the cyclic delay information, each of the plurality of PRSs being repeatedly received a predetermined number of times for a predetermined period of time and a respective one of the repeatedly received PRSs having different cyclic delay values with an interval, calculating a cross-correlation value of each of the plurality of received PRSs, and calculating a time difference of arrival (TDOA) value of each base station based on the cross-correlation value and reporting the calculated TDOA value to the serving base station.

Additionally or alternatively, each of the plurality of PRSs may have phase values which varies by predetermined time unit.

Additionally or alternatively, the phase values may be represented by phase sequences including complex values, and the phase sequences for the plurality of PRSs may be orthogonal to each other.

Additionally or alternatively, the plurality of PRSs may be transmitted through one antenna port of a base station.

Additionally or alternatively, the plurality of PRSs may be transmitted through a plurality of antenna ports of a base station.

Additionally or alternatively, the TDOA value of each base station may be acquired by performing a modulo operation on a difference value between a TOA of a reference base station and a TOA of a corresponding base station with respect to a value of the interval.

Additionally or alternatively, the method may further include identifying the plurality of PRSs by comparing a phase value of the cross-correlation value with the phase values varying by the predetermined time unit.

Additionally or alternatively, the method may further include reporting, to the serving base station, information about whether a maximum delay spread of a downlink channel is smaller than the interval.

In another aspect of the present invention, a terminal configured to receive a reference signal for determining a position in a wireless communication system, includes a radio frequency (RF) unit, and a processor configured to control the RF unit, wherein the processor is configured to receive, from a serving base station, cyclic delay information of a plurality of PRSs, receive the plurality of PRSs from a plurality of base stations using the cyclic delay information, each of the plurality of PRSs being repeatedly received a predetermined number of times for a predetermined period of time, and a respective one of the repeatedly received PRSs having different cyclic delay values with an interval, calculate a cross-correlation value of each of the plurality of received PRSs, calculate a time difference of arrival (TDOA) value of each base station based on the cross-correlation value and report the calculated TDOA value to the serving base station.

Additionally or alternatively, each of the plurality of PRSs may have phase values which varies by predetermined time unit.

Additionally or alternatively, the phase values may be represented by phase sequences including complex values, and the phase sequences for the plurality of PRSs may be orthogonal to each other.

Additionally or alternatively, the plurality of PRSs may be transmitted through one antenna port of a base station.

Additionally or alternatively, the plurality of PRSs may be transmitted through a plurality of antenna ports of a base station.

Additionally or alternatively, the TDOA value of each base station may be acquired by performing a modulo operation on a difference value between a TOA of a reference base station and a TOA of a corresponding base station with respect to a value of the interval.

Additionally or alternatively, the processor may be further configured to identify the plurality of PRSs by comparing a phase value of the cross-correlation value with the phase values varying by the predetermined time unit.

Additionally or alternatively, the processor may be further configured to report, to the serving base station, information about whether a maximum delay spread of a downlink channel is smaller than the interval.

It should be noted that the above-mentioned technical solutions are merely a part of embodiments of the present invention, and various embodiments reflecting technical characteristics of the present invention may be derived and understood by those skilled in the art from detailed description of the present invention given below.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1A and FIG. 1B are diagrams illustrating an example of a configuration of a radio frame used in a wireless communication system;

FIG. 2 is a diagram illustrating an example of a configuration of a downlink/uplink slot in the wireless communication system;

FIG. 3 is a diagram illustrating an example of a configuration of a downlink subframe used in a 3rd generation partnership project (3GPP) long term evolution (LTE)/LTE-advanced (LTE-A) system;

FIG. 4 is a diagram illustrating an example of a configuration of an uplink subframe used in the 3GPP LTE/LTE-A system;

FIG. 5 is a diagram illustrating a positioning reference signal (PRS) transmission configuration;

FIG. 6 is a diagram illustrating that PRSs are mapped to resource elements (REs);

FIG. 7 is a diagram illustrating a cross-correlation value of a PRS according to an embodiment of the present invention;

FIG. 8 is a diagram illustrating a cross-correlation value of a PRS according to another embodiment of the present invention;

FIG. 9 is a diagram illustrating a cross-correlation value of a PRS according to another embodiment of the present invention;

FIG. 10 is a diagram illustrating multiple paths between a transmitter and a receiver;

FIG. 11 is a diagram illustrating a scheme of determining a time difference of arrival (TDOA) according to an embodiment of the present invention;

FIG. 12 is a diagram illustrating an operation according to an embodiment of the present invention; and

### DETAILED DESCRIPTION OF THE INVENTION

Reference will now be made in detail to the preferred embodiments of the present invention, examples of which are illustrated in the accompanying drawings. The accompanying drawings illustrate exemplary embodiments of the present invention and provide a more detailed description of the present invention. However, the scope of the present invention should not be limited thereto.

In some cases, to prevent the concept of the present invention from being ambiguous, structures and apparatuses of the known art will be omitted, or will be shown in the form of a block diagram based on main functions of each structure and apparatus. Also, wherever possible, the same reference numbers will be used throughout the drawings and the specification to refer to the same or like parts.

In the present invention, a user equipment (UE) is fixed or mobile. The UE is a device that transmits and receives user data and/or control information by communicating with a base station (BS). The term ‘UE’ may be replaced with ‘terminal equipment’, ‘Mobile Station (MS)’, ‘Mobile Terminal (MT)’, ‘User Terminal (UT)’, ‘Subscriber Station (SS)’, ‘wireless device’, ‘Personal Digital Assistant (PDA)’, ‘wireless modem’, ‘handheld device’, etc. A BS is typically a fixed station that communicates with a UE and/or another BS. The BS exchanges data and control information with a UE and another BS. The term ‘BS’ may be replaced with ‘Advanced Base Station (ABS)’, ‘Node B’, ‘evolved-Node B (eNB)’, ‘Base Transceiver System (BTS)’, ‘Access Point (AP)’, ‘Processing Server (PS)’, etc. In the following description, BS is commonly called eNB.

In the present invention, a node refers to a fixed point capable of transmitting/receiving a radio signal to/from a UE by communication with the UE. Various eNBs can be used as nodes. For example, a node can be a BS, NB, eNB, pico-cell eNB (PeNB), home eNB (HeNB), relay, repeater, etc. Furthermore, a node may not be an eNB. For example, a node can be a radio remote head (RRH) or a radio remote unit (RRU). The RRH and RRU have power levels lower than that of the eNB. Since the RRH or RRU (referred to as RRH/RRU hereinafter) is connected to an eNB through a dedicated line such as an optical cable in general, cooperative communication according to RRH/RRU and eNB can be smoothly performed compared to cooperative communication according to eNBs connected through a wireless link. At least one antenna is installed per node. An antenna may refer to an antenna port, a virtual antenna or an antenna group. A node may also be called a point. Unlink a conventional centralized antenna system (CAS) (i.e. single node system) in which antennas are concentrated in an eNB and controlled an eNB controller, plural nodes are spaced apart at a predetermined distance or longer in a multi-node system. The plural nodes can be managed by one or more eNBs or eNB controllers that control operations of the nodes or schedule data to be transmitted/received through the nodes. Each node may be connected to an eNB or eNB controller managing the corresponding node via a cable or a dedicated line. In the multi-node system, the same cell identity (ID) or different cell IDs may be used for signal transmission/reception through plural nodes. When plural nodes have the same cell ID, each of the plural nodes operates as an antenna group of a cell. If nodes have different cell IDs in the multi-node system, the multi-node system can be regarded as a multi-cell (e.g., macro-cell/femto-cell/pico-cell) system. When multiple cells respectively configured by plural nodes are overlaid according to coverage, a network configured by multiple cells is called a multi-tier network. The cell ID of the RRH/RRU may be identical to or different from the cell ID of an eNB. When the RRH/RRU and eNB use different cell IDs, both the RRH/RRU and eNB operate as independent eNBs.

A communication scheme through which signals are transmitted/received via plural transmit (Tx)/receive (Rx) nodes, signals are transmitted/received via at least one node selected from plural Tx/Rx nodes, or a node transmitting a downlink signal is discriminated from a node transmitting an uplink signal is called multi-eNB MIMO or CoMP (Coordinated Multi-Point Tx/Rx). Coordinated transmission schemes from among CoMP communication schemes can be categorized into JP (Joint Processing) and scheduling coordination. The former may be divided into JT (Joint Transmission)/JR (Joint Reception) and DPS (Dynamic Point Selection) and the latter may be divided into CS (Coordinated Scheduling) and CB (Coordinated Beamforming). DPS may be called DCS (Dynamic Cell Selection). When JP is performed, more various communication environments can be generated, compared to other CoMP schemes. JT refers to a communication scheme by which plural nodes transmit the same stream to a UE and JR refers to a communication scheme by which plural nodes receive the same stream from the UE. The UE/eNB combine signals received from the plural nodes to restore the stream. In the case of JT/JR, signal transmission reliability can be improved according to transmit diversity since the same stream is transmitted from/to plural nodes. DPS refers to a communication scheme by which a signal is transmitted/received through a node selected from plural nodes according to a specific rule. In the case of DPS, signal transmission reliability can be improved because a node having a good channel state between the node and a UE is selected as a communication node.

In the present invention, a cell refers to a specific geographical area in which one or more nodes provide communication services. Accordingly, communication with a specific cell may mean communication with an eNB or a node providing communication services to the specific cell. A downlink/uplink signal of a specific cell refers to a downlink/uplink signal from/to an eNB or a node providing communication services to the specific cell. A cell providing uplink/downlink communication services to a UE is called a serving cell. Furthermore, channel status/quality of a specific cell refers to channel status/quality of a channel or a communication link generated between an eNB or a node providing communication services to the specific cell and a UE. In 3GPP LTE-A systems, a UE can measure downlink channel state from a specific node using one or more CSI-RSs (Channel State Information Reference Signals) transmitted through antenna port(s) of the specific node on a CSI-RS resource allocated to the specific node. In general, neighboring nodes transmit CSI-RS resources on orthogonal CSI-RS resources. When CSI-RS resources are orthogonal, this means that the CSI-RS resources have different subframe configurations and/or CSI-RS sequences which specify subframes to which CSI-RSs are allocated according to CSI-RS resource configurations, subframe offsets and transmission periods, etc. which specify symbols and subcarriers carrying the CSI RSs.

In the present invention, PDCCH (Physical Downlink Control Channel)/PCFICH (Physical Control Format Indicator Channel)/PHICH (Physical Hybrid automatic repeat request Indicator Channel)/PDSCH (Physical Downlink Shared Channel) refer to a set of time-frequency resources or resource elements respectively carrying DCI (Downlink Control Information)/CFI (Control Format Indicator)/downlink ACK/NACK (Acknowledgement/Negative ACK)/downlink data. In addition, PUCCH (Physical Uplink Control Channel)/PUSCH (Physical Uplink Shared Channel)/PRACH (Physical Random Access Channel) refer to sets of time-frequency resources or resource elements respectively carrying UCI (Uplink Control Information)/uplink data/random access signals. In the present invention, a time-frequency resource or a resource element (RE), which is allocated to or belongs to PDCCH/PCFICH/PHICH/PDSCH/PUCCH/PUSCH/PRACH, is referred to as a PDCCH/PCFICH/PHICH/PDSCH/PUCCH/PUSCH/PRACH RE or PDCCH/PCFICH/PHICH/PDSCH/PUCCH/PUSCH/PRACH resource. In the following description, transmission of PUCCH/PUSCH/PRACH by a UE is equivalent to transmission of uplink control information/uplink data/random access signal through or on PUCCH/PUSCH/PRACH. Furthermore, transmission of PDCCH/PCFICH/PHICH/PDSCH by an eNB is equivalent to transmission of downlink data/control information through or on PDCCH/PCFICH/PHICH/PDSCH.

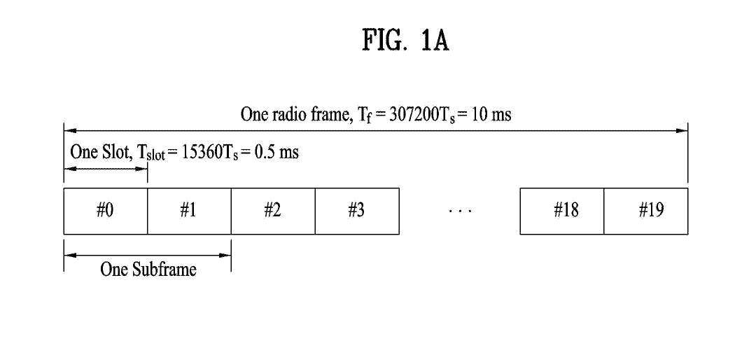

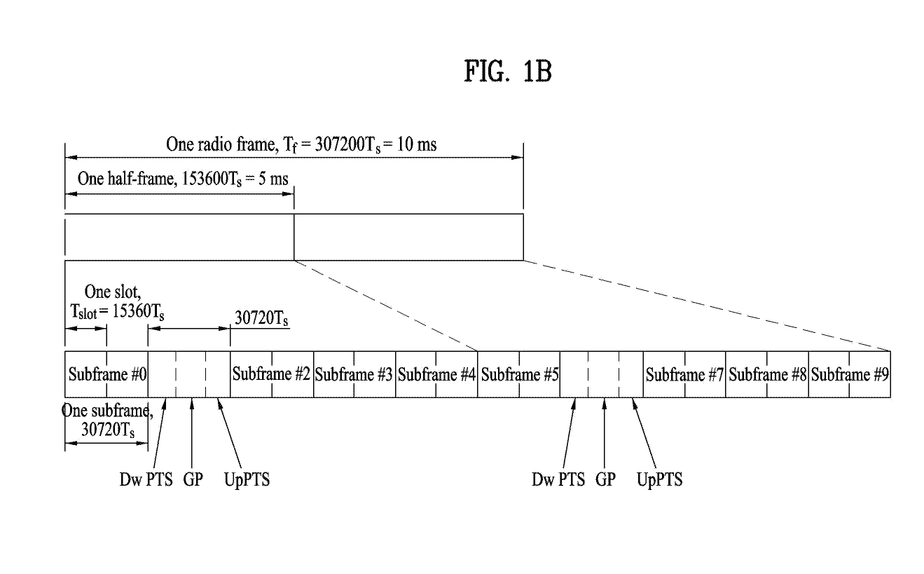

FIG. 1 illustrates an exemplary radio frame structure used in a wireless communication system. FIG. 1A illustrates a frame structure for frequency division duplex (FDD) used in 3GPP LTE/LTE-A and FIG. 1B illustrates a frame structure for time division duplex (TDD) used in 3GPP LTE/LTE-A.

Referring to FIG. 1, a radio frame used in 3GPP LTE/LTE-A has a length of 10 ms (307200 Ts) and includes 10 subframes in equal size. The 10 subframes in the radio frame may be numbered. Here, Ts denotes sampling time and is represented as Ts=1/(2048*15 kHz). Each subframe has a length of lms and includes two slots. 20 slots in the radio frame can be sequentially numbered from 0 to 19. Each slot has a length of 0.5 ms. A time for transmitting a subframe is defined as a transmission time interval (TTI). Time resources can be discriminated by a radio frame number (or radio frame index), subframe number (or subframe index) and a slot number (or slot index).

The radio frame can be configured differently according to duplex mode. Downlink transmission is discriminated from uplink transmission by frequency in FDD mode, and thus the radio frame includes only one of a downlink subframe and an uplink subframe in a specific frequency band. In TDD mode, downlink transmission is discriminated from uplink transmission by time, and thus the radio frame includes both a downlink subframe and an uplink subframe in a specific frequency band.

Table 1 shows DL-UL configurations of subframes in a radio frame in the TDD mode.

TABLE 1

| | Downlink- | | | | | | | | | | |
|---|---|---|---|---|---|---|---|---|---|---|---|
| | to-Uplink | | | | | | | | | | |
| | Switch- | | | | | | | | | | |
| DL-UL | point | Subframe number | | | | | | | | | |
| configuration | periodicity | 0 | 1 | 2 | 3 | 4 | 5 | 6 | 7 | 8 | 9 |
| 0 | 5 ms | D | S | U | U | U | D | S | U | U | U |
| 1 | 5 ms | D | S | U | U | D | D | S | U | U | D |
| 2 | 5 ms | D | S | U | D | D | D | S | U | D | D |
| 3 | 10 ms | D | S | U | U | U | D | D | D | D | D |
| 4 | 10 ms | D | S | U | U | D | D | D | D | D | D |
| 5 | 10 ms | D | S | U | D | D | D | D | D | D | D |
| 6 | 5 ms | D | S | U | U | U | D | S | U | U | D |

In Table 1, D denotes a downlink subframe, U denotes an uplink subframe and S denotes a special subframe. The special subframe includes three fields of DwPTS (Downlink Pilot TimeSlot), GP (Guard Period), and UpPTS (Uplink Pilot TimeSlot). DwPTS is a period reserved for downlink transmission and UpPTS is a period reserved for uplink transmission. Table 2 shows special subframe configuration.

TABLE 2

| | Normal cyclic prefix in downlink | | | Extended cyclic prefix in downlink | | |
|---|---|---|---|---|---|---|
| | | UpPTS | | | UpPTS | |
| Special | | Normal cyclic | Extended | | Normal | Extended |
| subframe | | prefix in | cyclic prefix | | cyclic prefix | cyclic prefix |
| configuration | DwPTS | uplink | in uplink | DwPTS | in uplink | in uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

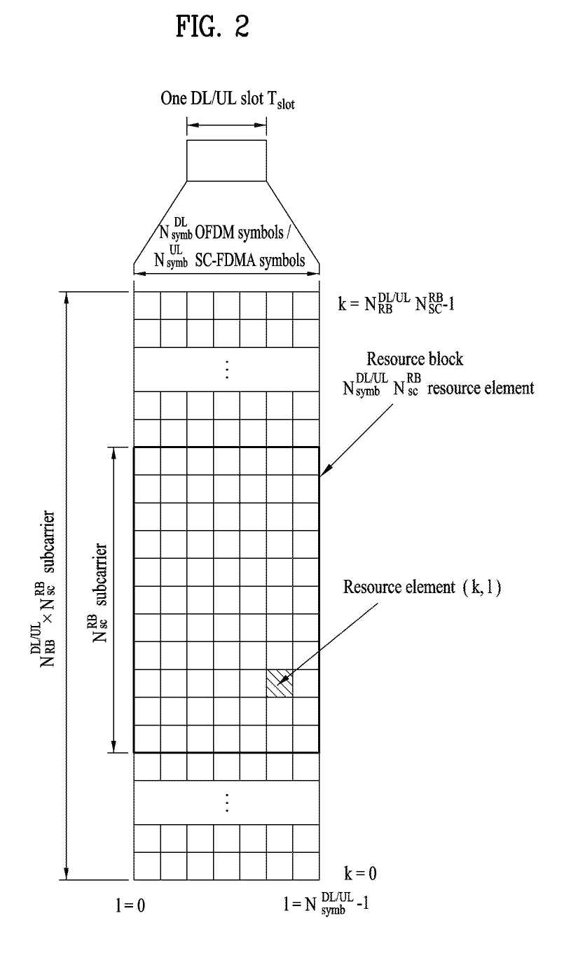

FIG. 2 illustrates an exemplary downlink/uplink slot structure in a wireless communication system. Particularly, FIG. 2 illustrates a resource grid structure in 3GPP LTE/LTE-A. A resource grid is present per antenna port.

Referring to FIG. 2, a slot includes a plurality of OFDM (Orthogonal Frequency Division Multiplexing) symbols in the time domain and a plurality of resource blocks (RBs) in the frequency domain. An OFDM symbol may refer to a symbol period. A signal transmitted in each slot may be represented by a resource grid composed of N_{RB}^{DL/UL}*N_{sc}^{RB} subcarriers and N_{symb}^{DL/UL} OFDM symbols. Here, N_{RB}^{DL} denotes the number of RBs in a downlink slot and N_{RB}^{UL} denotes the number of RBs in an uplink slot. N_{RB}^{DL} and N_{RB}^{UL} respectively depend on a DL transmission bandwidth and a UL transmission bandwidth. N_{symb}^{DL} denotes the number of OFDM symbols in the downlink slot and N_{symb}^{UL} denotes the number of OFDM symbols in the uplink slot. In addition, N_{sc}^{RB} denotes the number of subcarriers constructing one RB.

An OFDM symbol may be called an SC-FDM (Single Carrier Frequency Division Multiplexing) symbol according to multiple access scheme. The number of OFDM symbols included in a slot may depend on a channel bandwidth and the length of a cyclic prefix (CP). For example, a slot includes 7 OFDM symbols in the case of normal CP and 6 OFDM symbols in the case of extended CP. While FIG. 2 illustrates a subframe in which a slot includes 7 OFDM symbols for convenience, embodiments of the present invention can be equally applied to subframes having different numbers of OFDM symbols. Referring to FIG. 2, each OFDM symbol includes N_{RB}^{DL/UL}*N_{sc}^{RB} subcarriers in the frequency domain. Subcarrier types can be classified into a data subcarrier for data transmission, a reference signal subcarrier for reference signal transmission, and null subcarriers for a guard band and a direct current (DC) component. The null subcarrier for a DC component is a subcarrier remaining unused and is mapped to a carrier frequency (f0) during OFDM signal generation or frequency up-conversion. The carrier frequency is also called a center frequency.

An RB is defined by N_{symb}^{DL/UL} (e.g., 7) consecutive OFDM symbols in the time domain and N_{sc}^{RB} (e.g., 12) consecutive subcarriers in the frequency domain. For reference, a resource composed by an OFDM symbol and a subcarrier is called a resource element (RE) or a tone. Accordingly, an RB is composed of N_{symb}^{DL/UL}*N_{sc}^{RB} REs. Each RE in a resource grid can be uniquely defined by an index pair (k, l) in a slot. Here, k is an index in the range of 0 to N_{symb}^{DL/UL}*N_{sc}^{RB}−1 in the frequency domain and l is an index in the range of 0 to N_{symb}^{DL/UL}−1.

Two RBs that occupy N_{sc}^{RB} consecutive subcarriers in a subframe and respectively disposed in two slots of the subframe are called a physical resource block (PRB) pair. Two RBs constituting a PRB pair have the same PRB number (or PRB index). A virtual resource block (VRB) is a logical resource allocation unit for resource allocation. The VRB has the same size as that of the PRB. The VRB may be divided into a localized VRB and a distributed VRB depending on a mapping scheme of VRB into PRB. The localized VRBs are mapped into the PRBs, whereby VRB number (VRB index) corresponds to PRB number. That is, nPRB=nVRB is obtained. Numbers are given to the localized VRBs from 0 to N_{VRB}^{DL}−1, and N_{VRB}^{DL}=N_{RB}^{DL} is obtained. Accordingly, according to the localized mapping scheme, the VRBs having the same VRB number are mapped into the PRBs having the same PRB number at the first slot and the second slot. On the other hand, the distributed VRBs are mapped into the PRBs through interleaving. Accordingly, the VRBs having the same VRB number may be mapped into the PRBs having different PRB numbers at the first slot and the second slot. Two PRBs, which are respectively located at two slots of the subframe and have the same VRB number, will be referred to as a pair of VRBs.

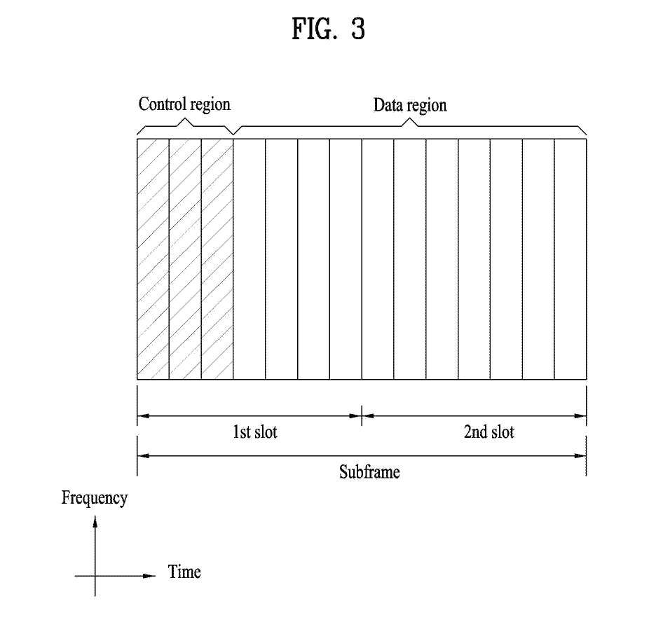

FIG. 3 illustrates a downlink (DL) subframe structure used in 3GPP LTE/LTE-A.

Referring to FIG. 3, a DL subframe is divided into a control region and a data region. A maximum of three (four) OFDM symbols located in a front portion of a first slot within a subframe correspond to the control region to which a control channel is allocated. A resource region available for PDCCH transmission in the DL subframe is referred to as a PDCCH region hereinafter. The remaining OFDM symbols correspond to the data region to which a physical downlink shared chancel (PDSCH) is allocated. A resource region available for PDSCH transmission in the DL subframe is referred to as a PDSCH region hereinafter. Examples of downlink control channels used in 3GPP LTE include a physical control format indicator channel (PCFICH), a physical downlink control channel (PDCCH), a physical hybrid ARQ indicator channel (PHICH), etc. The PCFICH is transmitted at a first OFDM symbol of a subframe and carries information regarding the number of OFDM symbols used for transmission of control channels within the subframe. The PHICH is a response of uplink transmission and carries an HARQ acknowledgment (ACK)/negative acknowledgment (NACK) signal.

Control information carried on the PDCCH is called downlink control information (DCI). The DCI contains resource allocation information and control information for a UE or a UE group. For example, the DCI includes a transport format and resource allocation information of a downlink shared channel (DL-SCH), a transport format and resource allocation information of an uplink shared channel (UL-SCH), paging information of a paging channel (PCH), system information on the DL-SCH, information about resource allocation of an upper layer control message such as a random access response transmitted on the PDSCH, a transmit control command set with respect to individual UEs in a UE group, a transmit power control command, information on activation of a voice over IP (VoIP), downlink assignment index (DAI), etc. The transport format and resource allocation information of the DL-SCH are also called DL scheduling information or a DL grant and the transport format and resource allocation information of the UL-SCH are also called UL scheduling information or a UL grant. The size and purpose of DCI carried on a PDCCH depend on DCI format and the size thereof may be varied according to coding rate. Various formats, for example, formats 0 and 4 for uplink and formats 1, 1A, 1B, 1C, 1D, 2, 2A, 2B, 2C, 3 and 3A for downlink, have been defined in 3GPP LTE. Control information such as a hopping flag, information on RB allocation, modulation coding scheme (MCS), redundancy version (RV), new data indicator (NDI), information on transmit power control (TPC), cyclic shift demodulation reference signal (DMRS), UL index, channel quality information (CQI) request, DL assignment index, HARQ process number, transmitted precoding matrix indicator (TPMI), precoding matrix indicator (PMI), etc. is selected and combined based on DCI format and transmitted to a UE as DCI.

In general, a DCI format for a UE depends on transmission mode (TM) set for the UE. In other words, only a DCI format corresponding to a specific TM can be used for a UE configured in the specific TM.

A PDCCH is transmitted on an aggregation of one or several consecutive control channel elements (CCEs). The CCE is a logical allocation unit used to provide the PDCCH with a coding rate based on a state of a radio channel. The CCE corresponds to a plurality of resource element groups (REGs). For example, a CCE corresponds to 9 REGs and an REG corresponds to 4 REs. 3GPP LTE defines a CCE set in which a PDCCH can be located for each UE. A CCE set from which a UE can detect a PDCCH thereof is called a PDCCH search space, simply, search space. An individual resource through which the PDCCH can be transmitted within the search space is called a PDCCH candidate. A set of PDCCH candidates to be monitored by the UE is defined as the search space. In 3GPP LTE/LTE-A, search spaces for DCI formats may have different sizes and include a dedicated search space and a common search space. The dedicated search space is a UE-specific search space and is configured for each UE. The common search space is configured for a plurality of UEs. Aggregation levels defining the search space is as follows.

TABLE 3

| Search Space | | | |
|---|---|---|---|
| | Aggregation Level | Size | Number of PDCCH |
| Type | L | [in CCEs] | candidates M^{(L)} |
| UE-specific | 1 | 6 | 6 |
| | 2 | 12 | 6 |
| | 4 | 8 | 2 |
| | 8 | 16 | 2 |
| Common | 4 | 16 | 4 |
| | 8 | 16 | 2 |

A PDCCH candidate corresponds to 1, 2, 4 or 8 CCEs according to CCE aggregation level. An eNB transmits a PDCCH (DCI) on an arbitrary PDCCH candidate with in a search space and a UE monitors the search space to detect the PDCCH (DCI). Here, monitoring refers to attempting to decode each PDCCH in the corresponding search space according to all monitored DCI formats. The UE can detect the PDCCH thereof by monitoring plural PDCCHs. Since the UE does not know the position in which the PDCCH thereof is transmitted, the UE attempts to decode all PDCCHs of the corresponding DCI format for each subframe until a PDCCH having the ID thereof is detected. This process is called blind detection (or blind decoding (BD)).

The eNB can transmit data for a UE or a UE group through the data region. Data transmitted through the data region may be called user data. For transmission of the user data, a physical downlink shared channel (PDSCH) may be allocated to the data region. A paging channel (PCH) and downlink-shared channel (DL-SCH) are transmitted through the PDSCH. The UE can read data transmitted through the PDSCH by decoding control information transmitted through a PDCCH. Information representing a UE or a UE group to which data on the PDSCH is transmitted, how the UE or UE group receives and decodes the PDSCH data, etc. is included in the PDCCH and transmitted. For example, if a specific PDCCH is CRC (cyclic redundancy check)-masked having radio network temporary identify (RNTI) of “A” and information about data transmitted using a radio resource (e.g., frequency position) of “B” and transmission format information (e.g., transport block size, modulation scheme, coding information, etc.) of “C” is transmitted through a specific DL subframe, the UE monitors PDCCHs using RNTI information and a UE having the RNTI of “A” detects a PDCCH and receives a PDSCH indicated by “B” and “C” using information about the PDCCH.

A reference signal (RS) to be compared with a data signal is necessary for the UE to demodulate a signal received from the eNB. A reference signal refers to a predetermined signal having a specific waveform, which is transmitted from the eNB to the UE or from the UE to the eNB and known to both the eNB and UE. The reference signal is also called a pilot. Reference signals are categorized into a cell-specific RS shared by all UEs in a cell and a modulation RS (DM RS) dedicated for a specific UE. A DM RS transmitted by the eNB for demodulation of downlink data for a specific UE is called a UE-specific RS. Both or one of DM RS and CRS may be transmitted on downlink. When only the DM RS is transmitted without CRS, an RS for channel measurement needs to be additionally provided because the DM RS transmitted using the same precoder as used for data can be used for demodulation only. For example, in 3GPP LTE(-A), CSI-RS corresponding to an additional RS for measurement is transmitted to the UE such that the UE can measure channel state information. CSI-RS is transmitted in each transmission period corresponding to a plurality of subframes based on the fact that channel state variation with time is not large, unlike CRS transmitted per subframe.

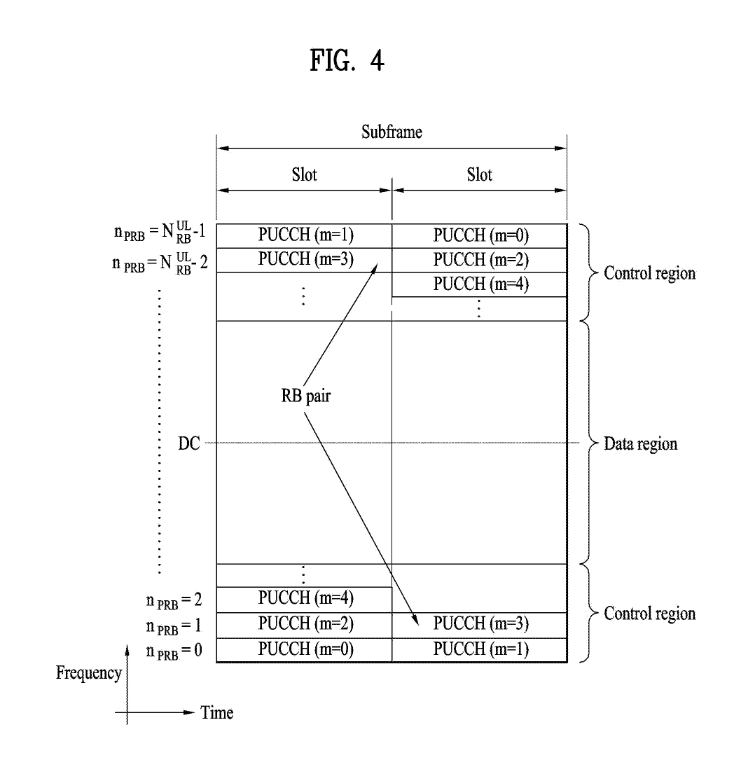

FIG. 4 illustrates an exemplary uplink subframe structure used in 3GPP LTE/LTE-A.

Referring to FIG. 4, a UL subframe can be divided into a control region and a data region in the frequency domain. One or more PUCCHs (physical uplink control channels) can be allocated to the control region to carry uplink control information (UCI). One or more PUSCHs (Physical uplink shared channels) may be allocated to the data region of the UL subframe to carry user data.

In the UL subframe, subcarriers spaced apart from a DC subcarrier are used as the control region. In other words, subcarriers corresponding to both ends of a UL transmission bandwidth are assigned to UCI transmission. The DC subcarrier is a component remaining unused for signal transmission and is mapped to the carrier frequency f0 during frequency up-conversion. A PUCCH for a UE is allocated to an RB pair belonging to resources operating at a carrier frequency and RBs belonging to the RB pair occupy different subcarriers in two slots. Assignment of the PUCCH in this manner is represented as frequency hopping of an RB pair allocated to the PUCCH at a slot boundary. When frequency hopping is not applied, the RB pair occupies the same subcarrier.

The PUCCH can be used to transmit the following control information.
Scheduling Request (SR): This is information used to request a UL-SCH resource and is transmitted using On-Off Keying (OOK) scheme.
HARQ ACK/NACK: This is a response signal to a downlink data packet on a PDSCH and indicates whether the downlink data packet has been successfully received. A 1-bit ACK/NACK signal is transmitted as a response to a single downlink codeword and a 2-bit ACK/NACK signal is transmitted as a response to two downlink codewords. HARQ-ACK responses include positive ACK (ACK), negative ACK (HACK), discontinuous transmission (DTX) and NACK/DTX. Here, the term HARQ-ACK is used interchangeably with the term HARQ ACK/NACK and ACK/NACK.
Channel State Indicator (CSI): This is feedback information about a downlink channel. Feedback information regarding MIMO includes a rank indicator (RI) and a precoding matrix indicator (PMI).

The quantity of control information (UCI) that a UE can transmit through a subframe depends on the number of SC-FDMA symbols available for control information transmission. The SC-FDMA symbols available for control information transmission correspond to SC-FDMA symbols other than SC-FDMA symbols of the subframe, which are used for reference signal transmission. In the case of a subframe in which a sounding reference signal (SRS) is configured, the last SC-FDMA symbol of the subframe is excluded from the SC-FDMA symbols available for control information transmission. A reference signal is used to detect coherence of the PUCCH. The PUCCH supports various formats according to information transmitted thereon. Table 4 shows the mapping relationship between PUCCH formats and UCI in LTE/LTE-A.

TABLE 4

| | | Number of | | |
|---|---|---|---|---|
| | | bits per | | |
| PUCCH | Modulation | subframe, | | |
| format | scheme | M_{bit} | Usage | Etc. |
| 1 | N/A | N/A | SR (Scheduling | |
| | | | Request) | |
| 1a | BPSK | 1 | ACK/NACK or | One |
| | | | SR + ACK/NACK | codeword |
| 1b | QPSK | 2 | ACK/NACK or | Two |
| | | | SR + ACK/NACK | codeword |
| 2 | QPSK | 20 | CQI/PMI/RI | Joint coding |
| | | | | ACK/NACK |
| | | | | (extended |
| | | | | CP) |
| 2a | QPSK + | 21 | CQI/PMI/RI + | Normal CP |
| | BPSK | | ACK/NACK | only |
| 2b | QPSK + | 22 | CQI/PMI/RI + | Normal CP |
| | QPSK | | ACK/NACK | only |
| 3 | QPSK | 48 | ACK/NACK or | |
| | | | SR + ACK/NACK or | |
| | | | CQI/PMI/RI + | |
| | | | ACK/NACK | |

Referring to Table 4, PUCCH formats 1/1a/1b are used to transmit ACK/NACK information, PUCCH format 2/2a/2b are used to carry CSI such as CQI/PMFRI and PUCCH format 3 is used to transmit ACK/NACK information.

In general, a cellular communication system uses several schemes to enable a network to acquire location information of a terminal. Typically, an observed time difference of arrival (OTDOA) scheme has been introduced in an LTE Rel-9 system. In this scheme, an eNB (i.e., evolved Node B) transmits a positioning reference signal (PRS), and a terminal estimates a reference signal time difference (RSTD) from the PRS using a TDOA scheme and delivers the estimated RSTD to a network.

[LTE Positioning Protocol]

In an LTE system, an LTE positioning protocol (LPP) is defined to support the OTDOA scheme. In the LPP, OTDOA-ProvideAssistanceData having a configuration below is reported as an information element (IE) to the terminal.

-- ASN1START
OTDOA-ProvideAssistanceData ::= SEQUENCE {

| | | |
|---|---|---|
| otdoa-ReferenceCellInfo | OTDOA-ReferenceCellInfo | OPTIONAL, -- Need ON |
| otdoa-NeighbourCellInfo | OTDOA-NeighbourCellInfoList | OPTIONAL, -- Need ON |
| otdoa-Error | OTDOA-Error | OPTIONAL, -- Need ON |
| ... | | |
| } | | |
| -- ASN1STOP | | |

Here, OTDOA-ReferenceCelllnfo refers to a cell corresponding to a metric for an RSTD, and is configured as below.

-- ASN1START
OTDOA-ReferenceCellInfo ::= SEQUENCE {

| physCellId | INTEGER (0..503), | | |
|---|---|---|---|
| cellGlobalId | ECGI | OPTIONAL, | -- Need ON |
| earfcnRef | ARFCN-ValueEUTRA | OPTIONAL, | -- Cond |
| NotSameAsServ0 | | | |
| antennaPortConfig | ENUMERATED {ports1-or-2, ports4, ... } | | |
| | | OPTIONAL, | -- Cond |
| NotSameAsServ1 | | | |
| cpLength | ENUMERATED { normal, extended, ... }, | | |
| prsInfo | PRS-Info | OPTIONAL, | -- Cond PRS |
| ..., | | | |
| [[ earfcnRef-v9a0 | ARFCN-ValueEUTRA-v9a0 | OPTIONAL | -- Cond |
| NotSameAsServ2 | | | |
| ]] | | | |
| } | | | |
| -- ASN1STOP | | | |

Meanwhile, OTDOA-NeighbourCelllnfo refers to cells (e.g., eNBs or TPs) to be subjected to measurement of an RSTD, and a maximum of 24 adjacent cell information items may be included in each frequency layer for a maximum of three frequency layers. In other words, information about 3*24=72 cells in total may be reported to a terminal.

-- ASN1START
OTDOA-NeighbourCellInfoList ::= SEQUENCE (SIZE (1 . . . maxFreqLayers)) OF OTDOA-NeighbourFreqInfo
OTDOA-NeighbourFreqInfo ::= SEQUENCE (SIZE (1 . . . 24)) OF OTDOA-NeighbourCellInfoElement
OTDOA-NeighbourCellInfoElement ::= SEQUENCE {

| physCellId | INTEGER (0 . . . 503), | | |
|---|---|---|---|
| cellGlobalId | ECGI | OPTIONAL, | -- Need ON |
| earfcn | ARFCN-ValueEUTRA | OPTIONAL, | -- Cond |
| NotSameAsRef0 | | | |
| cpLength | ENUMERATED {normal, extended, . . . } | | |
| | | OPTIONAL, | -- Cond |
| NotSameAsRef1 | | | |
| prsInfo | PRS-Info | OPTIONAL, | -- Cond |
| NotSameAsRef2 | | | |
| antennaPortConfig | ENUMERATED {ports-1-or-2, ports-4, . . . } | | |
| | | OPTIONAL, | -- Cond |
| NotsameAsRef3 | | | |
| slotNumberOffset | INTEGER (0 . . . 19) | OPTIONAL, | -- Cond |
| NotSameAsRef4 | | | |
| prs-SubframeOffset | INTEGER (0 . . . 1279) | OPTIONAL, | -- Cond InterFreq |
| expectedRSTD | INTEGER (0 . . . 16383), | | |
| expectedRSTD-Uncertainty | INTEGER (0 . . . 1023), | | |
| . . . ., | | | |

| | | | |
|---|---|---|---|
| [[ earfcnRef-v9a0 | ARFCN-ValueEUTRA-v9a0 | OPTIONAL | -- Cond |
| NotSameAsRef5 | | | |
| ]] | | | |
| } | | | |
| maxFreqLayers INTEGER ::= 3 | | | |
| -- ASN1STOP | | | |

Here, PRS information is contained in PRS-Info corresponding to an IE included in OTDOA-ReferenceCelllnfo and OTDOA-NeighbourCelllnfo. Specifically, the PRS information corresponds to a PRS bandwidth, a PRS configuration index (I_{PRS}), the Number of Consecutive Downlink Subframes, and PRS Muting Information, and is configured as below.

| PRS-Info ::= SEQUENCE { | | | |
|---|---|---|---|
| prs-Bandwidth | ENUMERATED { n6, n15, n25, n50, n75, n100, . . . }, | | |
| prs-ConfigurationIndex | INTEGER (0 . . . 4095), | | |
| numDL-Frames | ENUMERATED {sf-1, sf-2, sf-4, sf-6, . . . }, | | |
| . . . , | | | |
| prs-MutingInfo-r9 | CHOICE { | | |
| po2-r9 | BIT STRING (SIZE(2)), | | |
| po4-r9 | BIT STRING (SIZE(4)), | | |
| po8-r9 | BIT STRING (SIZE(8)), | | |
| po16-r9 | BIT STRING (SIZE(16)), | | |
| . . . | | | |
| } | | OPTIONAL | -- Need OP |
| } | | | |
| -- ASN1STOP | | | |

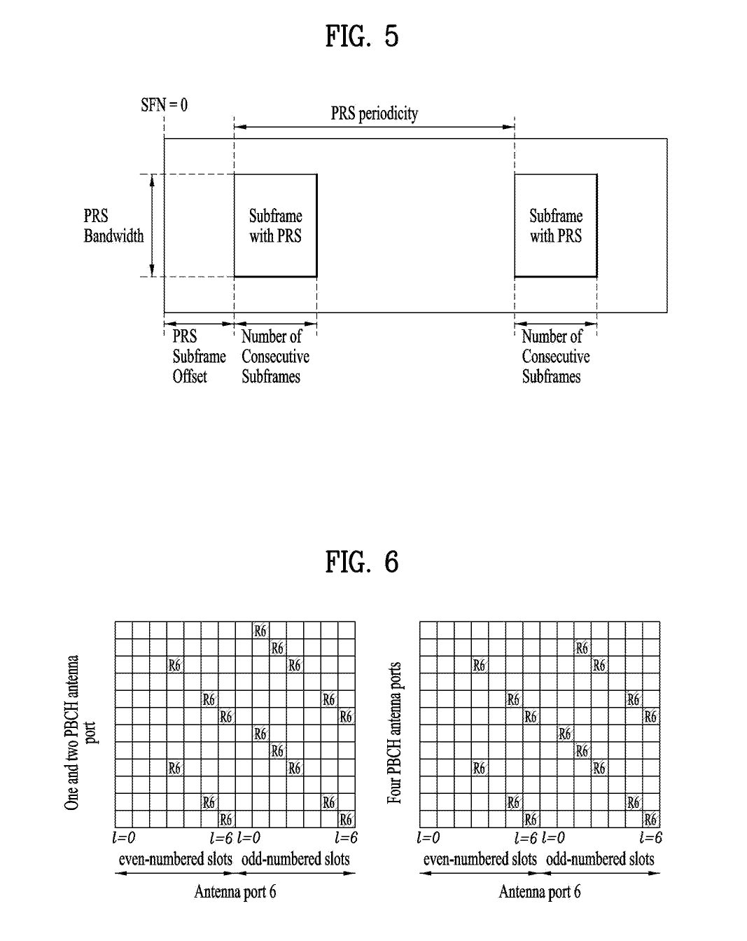

FIG. 5 illustrates a PRS transmission configuration according to the above parameters.

In this instance, a PRS periodicity and a PRS subframe offset are determined according to a value of a PRS configuration index (I_{PRS}), and a correlation therebetween is as in the following Table.

TABLE 5

| PRS Configuration | PRS Periodicity | PRS Subframe Offset |
|---|---|---|
| Index (I_{PRS}) | (subframes) | (subframes) |
| 0-159 | 160 | I_{PRS} |
| 160-479 | 320 | I_{PRS} − 160 |
| 480-1119 | 640 | I_{PRS} − 480 |
| 1120-23399 | 1280 | I_{PRS} − 1120 |

As an example of a scheme of estimating a TDOA based on the PRS, when an adjacent cell transmits a known signal x[n] such as a PRS, etc., the signal is received through a channel h[n] . In this instance, a terminal desiring to estimate the TDOA may obtain a correlation as in the following Equation 1.

$$\begin{matrix}{R}_{yx} [ m ] = {\sum }_{n = 0}^{N - 1} y [ n ] {x [ {( n - m )}_{N} ]}^{*} \\ = {\sum }_{n = 0}^{N - 1} ( {\sum }_{l = 0}^{N - 1} h [ l ] x [ {( n - l )}_{N} ] ) \cdot {x [ {( n - m )}_{N} ]}^{*} \\ = {\sum }_{l = 0}^{N - 1} h [ l ] \cdot ( {\sum }_{n = 0}^{N - 1} x [ {( n - l )}_{N} ] \cdot {x [ {( n - m )}_{N} ]}^{*} ) \\ = {\sum }_{l = 0}^{N - 1} h [ l ] \cdot {R}_{xx} [ {( m - l )}_{N} ] \\ = h [ m ] {•R}_{xx} [ m ]\end{matrix} \qquad [ Equation 1 ]$$

Here, n denotes an index on a time axis of a discrete time domain, (•)_{N} denotes a modulo operation with respect to N, ∘ denotes circular convolution, and X[k], Y[k], and H[k] correspond to discrete Fourier transformation (DFT) of x[n], y[n], and h[n], respectively. For example, X[k] is defined as below.

$$X ⌈ k ⌉ = {\sum }_{n = 0}^{N - 1} x ⌈ n ⌉ {e}^{- j \frac{2 π kn}{N}} \qquad [ Equation 2 ]$$

In addition, Rₓₓ[m] denotes auto-correlation of x[n] corresponding to a PRS, and is defined as below.

$${R}_{xx} [ m ] = {\sum }_{n = 0}^{N - 1} x [ n ] {x [ {( n - m )}_{N} ]}^{*} \qquad [ Equation 3 ]$$

A PRS has a transmission occasion, that is, a positioning occasion at an interval of 160, 320, 640, or 1280 ms, and the PRS may be transmitted in N contiguous DL subframes at the positioning occasion. Here, N may correspond to 1, 2, 4, or 6. The PRS may be substantially transmitted at the positioning occasion, and may be muted for inter-cell interference control cooperation. Information about PRS muting is reported to a UE as prs-Mutinglnfo. A transmission bandwidth of the PRS may be independently configured unlike a system bandwidth of a serving base station, and the PRS is transmitted in a frequency bandwidth of 6, 15, 25, 50, 75, or 100 resource blocks (RBs). A transmission sequence of the PRS is generated by initializing a pseudo-random sequence generator for every OFDM symbol using a function of a slot index, an OFDM symbol index, a cyclic prefix (CP) type, and a cell ID. Generated transmission sequences of the PRS are mapped to resource elements (REs) based on whether a normal CP or an extended CP is used. A position of a mapped RE may be shifted on the frequency axis, and a shift value is determined by a cell ID. FIG. 6 illustrates mapping of a PRS or a PRS sequence according to the number of antenna ports of a physical broadcast channel (PBCH) in a case of the normal CP in LTE Rel-9. Positions of PRS transmission REs illustrated in FIG. 6 correspond to a case in which a frequency shift is 0.

A UE receives designated configuration information about a list of PRSs to be searched from a position management server of a network to measure PRSs. The information includes PRS configuration information of a reference cell and PRS configuration information of an adjacent cell. Configuration information of each PRS includes a positioning occasion generation interval and offset, the number of contiguous DL subframes included in one positioning occasion, a cell ID used to generate a PRS sequence, a CP type, the number of CRS antenna ports considered at the time of PRS mapping, etc. In addition, the PRS configuration information of the adjacent cell includes a slot offset and a subframe offset of the adjacent cell and the reference cell, an expected RSTD, and a level of uncertainty of the expected RSTD to support determination of the UE when the UE determines a point in time and a level of time window used to search for the PRS to detect the PRS transmitted by the adjacent cell.

Meanwhile, the RSTD refers to a relative timing difference between an adjacent cell j and a reference cell i. In other words, the RSTD may be expressed by T_{subframeRxj}−T_{subframeRxi}. Here, T_{subframeRxj} refers to a point in time at which a terminal starts to receive a particular subframe from the adjacent cell j, and T_{subframeRxi} refers to a point in time at which a UE starts to receive a subframe, which is closest to the particular subframe received from the adjacent cell j in terms of time and corresponds to the particular subframe, from the reference cell i. A reference point for an observed subframe time difference is an antenna connector of the UE.

In this instance, the LTE Rel-9 PRS receives resources allocated at an interval of six subcarriers in one OFDM symbol, and thus the PRS is repeated six times on the time axis. For example, it is presumed that a PRS \tilde{X}[k] having a length of M_{f}·N₀ is created through zero insertion for a PRS sequence having a length of on the frequency axis (e.g., X[0], X[1], . . . , X[N₀−1]).

$$\tilde{X} [ k ] = \{ \begin{matrix}X [ i ] & k = {M}_{f} \cdot i \\ 0 & otherwise\end{matrix} \qquad [ Equation 4 ]$$

In this instance, M_{f}·N₀ Point IDFT is performed.

$$\begin{matrix}\tilde{x} [ n ] = \frac{1}{{M}_{f} {N}_{0}} {\sum }_{k = 0}^{{M}_{f} {N}_{0} - 1} \tilde{X} [ k ] {e}^{j \frac{2 π nk}{{M}_{f} {N}_{0}}} \\ = \frac{1}{{M}_{f}} ( \frac{1}{{N}_{0}} {\sum }_{i = 0}^{{N}_{0} - 1} X [ i ] {e}^{j \frac{2 π ni}{{N}_{0}}} ) \\ = \frac{1}{{M}_{f}} x [ {( n )}_{{N}_{0}} ]\end{matrix} \qquad [ Equation 5 ]$$

In other words, it is possible to verify that a PRS Sequence x[n] having a length of N₀ on the time axis is repeated M_{f} times. Here, a relation between an auto-correlation correlation R_{\tilde{x}\tilde{x}}[m] for \tilde{x}[n] subjected to a zero insertion process and an auto-correlation Rₓₓ[m] for \tilde{x}[n] is as below.

$${R}_{\tilde{x} \tilde{x}} [ m ] = \frac{1}{{M}_{f}} {R}_{xx} [ {( m )}_{{N}_{0}} ] \qquad [ Equation 6 ]$$

Therefore, in the above LTE Rel-9 PRS configuration, it is possible to calculate a correlation value for a range corresponding to a cyclic delay N₀=N/M_{f}. In this instance, a terminal may estimate a TOA value from each base station in a reference system of the terminal by estimating a time having a maximum value or a value greater than or equal to a certain threshold based on the above cross-correlation value. Then, a TDOA value of a PRS transmitted from a particular base station may be calculated as a difference between a TOA value of the PRS and a TOA value of a PRS transmitted from a base station serving as a reference.

Meanwhile, in an advanced wireless communication system such as 3GPP LTE Rel-13, etc., a positioning enhancement scheme for more accurately estimating a position of a terminal which is present in an indoor environment is considered in preparation for an emergency. However, when the terminal in the indoor environment receives a PRS transmitted from a base station in an outdoor environment, received power of the PRS in the terminal may be remarkably decreased since the PRS experiences severe path attenuation when penetrating an outer wall of a building. Moreover, multi-path propagation due to scattering is intensified as a result of a radio channel environment between the terminal and the base station becoming a non-line of sight (NLOS) environment, and thus accuracy of measurement of a TDOA may be degraded. Therefore, in order to enhance accuracy of measurement of a TDOA with respect to the terminal in the indoor environment, more PRS resources may be transmitted to accumulate more cross-correlation values, thereby overcoming path attenuation, or diversity gain may be achieved to mitigate effect of the NLOS environment. In other words, the base station preferably extends PRS transmission resources to enhance positioning performance of the terminal which is present in the indoor environment. However, according to a PRS resource allocation scheme of FIG. 6, a PRS has a frequency shift value by a physical cell ID (PCI). As a result, PRSs are uniformly distributed in a whole frequency resource region. Thus, when PRS resources are extended on the frequency axis, interference due to collisions with adjacent cell PRS resources may increase in proportion to the amount of the extended PRS resources. Alternatively, it is possible to consider a scheme of extending PRS resources on the time axis. However, in general, it is presumed that a subframe in which a PRS is transmitted is configured as a low interference subframe (LIS) in which a PDSCH is not transmitted for positioning performance. Therefore, as the PRS resources are extended on the time axis, PDSCH transmission resources decrease. As a result, resources may be inefficiently used.

In this regard, the present specification proposes a scheme of extending PRS resources without additional consumption of time and frequency resources by transmitting PRSs having different cyclic delays in the same frequency resource in one OFDM symbol.

[Operation of Base Station]

(1) PRS Transmission Configuration

(1.1) Cyclic Delay Configuration and Signaling for Each PRS

A specific example of the present invention proposes a scheme in which, when a PRS sequence \tilde{X}[k] is designed by performing M_{f}−1 zero insertions between respective elements based on a sequence X[k] having a length of in an OFDM symbol including N (=M_{f}N₀) subcarriers in total, a base station applies an independent cyclic delay dₚ(=p·N₀/P) to each p th PRS (p=0,1, . . . , P−1) to transmit \tilde{X}ₚ[k]=\tilde{X}[k]exp(−j2πkdₚ/N), and reports a cyclic delay of each PRS to a terminal. First, when a received signal passing through a channel is referred to as y[n]=h[n]\tilde{x}[n], a cross-correlation R_{y\tilde{x}}[m] may be expressed as in Equation below using Equation 1.

R_{y\tilde{x}}[m]=h[m]∘R_{\tilde{x}\tilde{x}}[m]

In addition, when the PRS sequence X[k] is presumed to be designed as a CAZAC( ) having an ideal auto-correlation characteristic (e.g., Rₓₓ[m]=δ[m]), the above Equation 7 may be expressed again as below.

$$\begin{matrix}{R}_{y \tilde{x}} [ m ] = h [ m ] • ( {\sum }_{l = 0}^{{M}_{f} - 1} δ [ m - {N}_{0} l ] ) \\ = {\sum }_{l = 0}^{{M}_{f} - 1} h [ {( m - {N}_{0} l )}_{N} ]\end{matrix} \qquad [ Equation 8 ]$$

In this instance, when a maximum delay spread of a channel is τₘₐₓ, the equation can be expressed in a form of a tapped delay line (TDL) in which a channel impulse response (CIR) h[n] of a discrete time domain has a valid value only when an inequality 0≦n≦Dₘₐₓ−1 is satisfied and has a value of 0 when an inequality Dₘₐₓ≦n≦N−1 is satisfied. Here, Dₘₐₓ refers to a value obtained by quantizing τₘₐₓ for each sample time according to a DFT size. It is presumed that Dₘₐₓ≦N₀/P, and a base station transmits P PRSs according to an operation of the present invention and receives a received signal z[n] as below.

$$\begin{matrix}z [ n ] = h [ n ] • ( {\sum }_{p = 0}^{P - 1} {\tilde{x}}_{p} [ n ] ) \\ = h [ n ] • ( {\sum }_{p = 0}^{P - 1} \tilde{x} [ {( n - p \cdot {N}_{0} / P )}_{N} ] )\end{matrix} \qquad [ Equation 9 ]$$

Then, a cross-correlation R_{z\tilde{x}}[m] may be expressed as in Equation below using Equations 8 and 9.

$${R}_{z \tilde{z}} [ m ] = {\sum }_{p = 0}^{P - 1} {\sum }_{l = 0}^{{M}_{f} - 1} h [ {( m - {N}_{0} l - p \cdot {N}_{0} / P )}_{N} ] \qquad [ Equation 10 ]$$

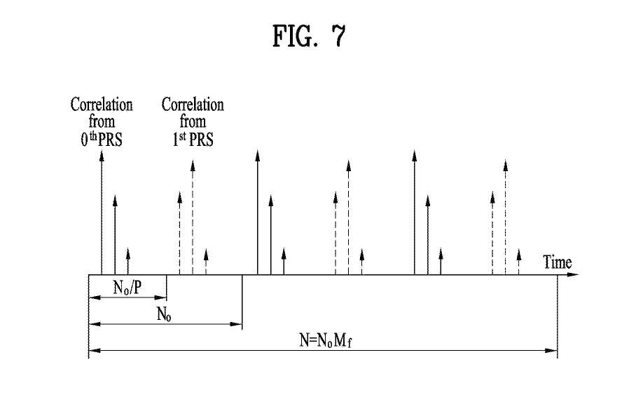

Here, since Dₘₐₓ≦N₀/P, the terminal may obtain a cross-correlation value generated by each p th PRS (p=0,1, . . . , P−1) by distinguishing the value for each PRS in an interval of k·N₀+p·(N₀/P)≦n≦k·N₀+(p+1)·(N₀/P), k=0,1, . . . , M_{f}−1. For example, it is presumed that M_{f}=3, and a maximum delay spread of a channel is sufficiently small, and thus p PRSs (P=2) may be distinguished on the time axis. Then, a cross-correlation corresponding to the above Equation 10 may be expressed as in FIG. 7.

Therefore, the base station transmits PRSs distinguished by cyclic delays to the terminal and reports cyclic delay information for each PRS to the terminal, thereby allowing independent acquisition of a cross-correlation for each PRS.

(1.2) Phase Change for Each Cyclic Delay

A specific example of the present invention proposes a scheme in which, when a plurality of PRSs is transmitted in the same frequency resource and cross-correlations corresponding to the respective PRSs are distinguished by applying cyclic delays based on the same PRS sequence as in the above operation (1.1), a base station independently applies a series of phase values (e.g., φₚ(l), l=0,1, . . . , L−1) varying according to time resources to the respective PRSs distinguished by the cyclic delays to repeatedly transmit the PRSs in L time resources, and informs a terminal of information about the series of phase values for the respective PRSs distinguished by the cyclic delays. When transmission is performed by applying cyclic delays based on the same PRS sequence as in the above operation of the present invention, the terminal may erroneously estimate a TDOA by erroneously applying cyclic delay information. For example, when the terminal fails to detect a 0th PRS and succeeds in detecting a first PRS in FIG. 7, the terminal has difficulty in determining whether the terminal succeeds in detecting the 0th PRS or succeeds in detecting the first PRS. Therefore, in order to assist in determination of the terminal, the present invention allows cross-correlation values corresponding to the PRSs distinguished by the cyclic delays to be distinguished by repeatedly transmitting the same PRS in L time resources andperforming transmission by applying a sequence (e.g., φₚ(l), l=0,1, . . . , L−1) of phase values varying according to time resources.

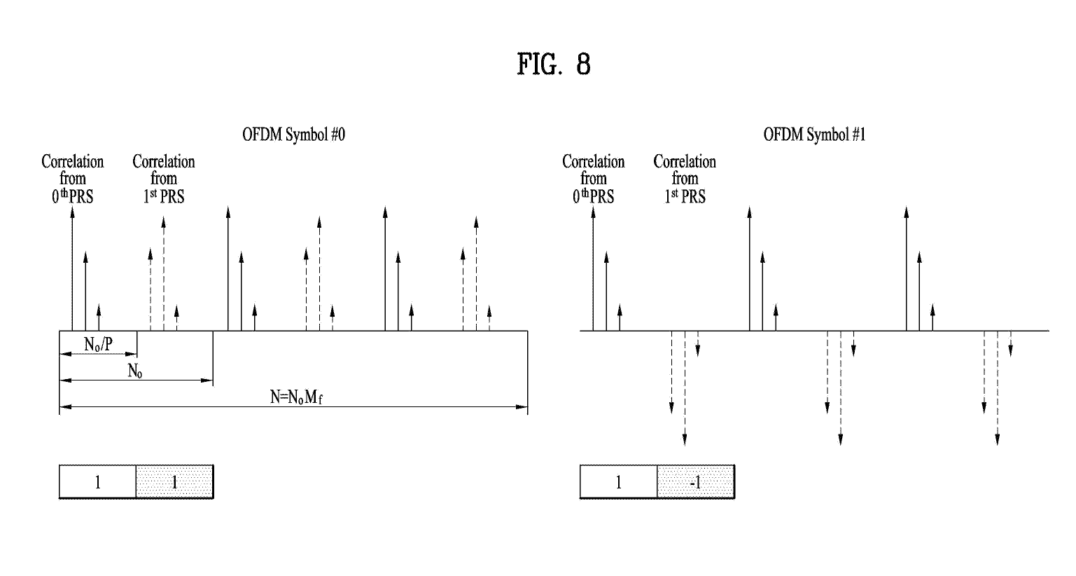

For example, when each p th PRS \tilde{X}ₚ[k] to which a cyclic delay dₚ is applied is repeatedly transmitted on L OFDM symbols in total as in operation (1.1), each p th PRS \tilde{X}ₚ[k] transmitted on each l th OFDM symbol may be transformed into exp(jφₚ(l))\tilde{X}ₚ[k] and transmitted by applying a phase value φₚ(l) varying over time thereto. In this instance, when a channel is presumed to be rarely changed in the L OFDM symbols, cross-correlation values for the same time offset derived by each p th PRS correspond to a phase difference according to a phase value φₚ(l) on the time axis in the L OFDM symbols. In this way, the terminal may distinguish a cross-correlation for each PRS. FIG. 8 schematically illustrates an example in which a PRS having a cross-correlation of FIG. 7 is transmitted over two OFDM symbols, phase values of 1 and 1 are applied to a 0th PRS, and phase values of 1 and −1 are applied to a first PRS.

Operation (1.2) may be elaborated using a code division multiplexing (CDM) scheme. In other words, when a plurality of PRSs is transmitted in the same frequency resource and cross-correlations corresponding to the respective PRSs are distinguished by applying cyclic delays based on the same sequence as in the above operation (1.1), a base station may independently apply a series of phase values (e.g., φₚ(l), l=0, 1, . . . , L−1) varying according to time resources to the respective PRSs distinguished by the cyclic delays to repeatedly transmit the PRSs in L time resources, and PRS sequences including complex phase values corresponding to the L phase values may be orthogonal to each other.

More specifically, a sequence └exp(jφₚ_{₁}(0)) . . . exp(jφₚ_{₁}(L−1))┘ of complex phase values applied to a p₁ th PRS and a sequence └exp(jφₚ_{₂}(0)) . . . exp(jφₚ_{₂}(L−1))┘ of complex phase values applied to a p₂ th PRS (e.g., p₁≠p₂) have a relation as in the following Equation.

[exp(jφₚ_{₁}(0)) . . . exp(jφₚ_{₁}(L−1))][exp(jφₚ_{₂}(0)) . . . exp(jφₚ_{₂}(L−1))]^{H}=0 [Equation 11]

Here, (•)^{H} denotes complex conjugate and transpose, that is, the Hermitian operator. For example, the sequence including the complex phase values applied to the p₁ th PRS may be generated based on the Walsh code. For example, in a case of L=4 , the sequence may be generated as in the following Table.

TABLE 5

| Walsh | Sequence |
|---|---|
| code | └exp(jφₚ (0)) . . . exp(jφₚ (L − 1))┘ |
| 0000 | +1 +1 +1 +1 |
| 0101 | +1 −1 +1 −1 |
| 0110 | +1 −1 −1 +1 |
| 0011 | +1 +1 −1 −1 |

(2) Configuration of Antenna Port

(2.1) Single Antenna Port Transmission

A specific example of the present invention proposes a scheme in which, when a plurality of PRSs is transmitted in the same frequency resource and cross-correlations corresponding to the respective PRSs are distinguished by applying cyclic delays to the same PRS sequence according to the above operation (1.1), a base station transmits the PRSs using the same antenna port and informs a terminal of the PRSs in a form of single PRS-Info having a plurality of cyclic delay values. Here, the PRS-Info refers to an information entity (IE) containing PRS information as mentioned above.

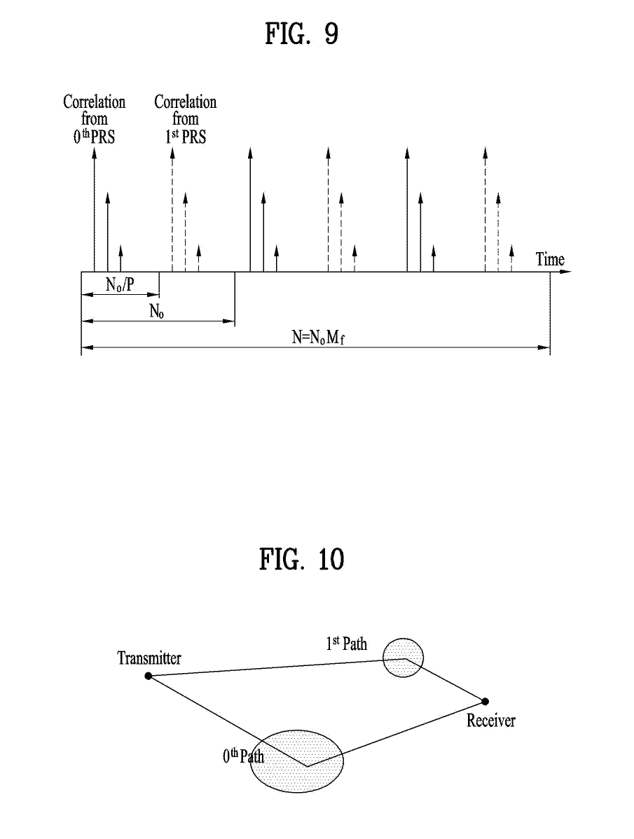

For example, it is presumed that the 0th PRS and the first PRS are transmitted using the same antenna port in a circumstance as in FIG. 7. Then, cross-correlations generated from the respective PRSs may be expected to have substantially the same cross-correlation value which is determined based on an auto-correlation of a PRS sequence and a channel component. FIG. 9 illustrates cross-correlation values of PRS transmitted from the same antenna port.

In this instance, when only the channel component is considered as in FIG. 9, the above transmission operation using the same antenna port has the same effect as simple transmission of the PRSs using doubled transmission power. However, at the time of actual reception, other noise signals may be received other than the channel component. In this instance, even though the 0th PRS and the first PRS are transmitted through the same antenna port and thus have the same correlation value for the channel component, the 0th PRS and the first PRS may experience different noises according to an interval in which a cross-correlation of each PRS is present. Therefore, when the PRSs distinguished by the cyclic delays are transmitted using the same antenna as in the above operation, transmission power may advantageously be boosted and noise may advantageously be suppressed. In this instance, the base station configures single PRS-Info having a plurality of cyclic delay values for the terminal, and the terminal implicitly measures and combines a plurality of cross-correlation values according to the PRS-Info in each divided interval when the plurality of cyclic delay values are included in the PRS-Info, thereby calculating the cross-correlation values corresponding to the PRS-Info.

(2.2) Multi-Antenna Port Transmission

A specific example of the present invention proposes a scheme in which, when a plurality of PRSs is transmitted in the same frequency resource and cross-correlations corresponding to the respective PRSs are distinguished by applying cyclic delays to the same PRS sequence according to the above operation (1.1), a base station transmits the PRSs through different antenna ports and configures a plurality of independent PRS-Info, each of which has a single cyclic delay value, for a terminal. Here, the PRS-Info refers to an IE containing PRS information as mentioned above. When a TDOA is estimated using PRSs according to the specific example of the present invention, if the terminal is in the NLOS environment in which a large amount of scatter is present in a radio channel to the base station, it is preferable to achieve diversity gain by transmitting the PRSs in more various directions. For example, it is presumed that two paths including a 0th path and a first path are present as in FIG. 10.

In FIG. 10, the first path may have a smaller TOA value than that of the 0th path, and a minimum value of TOA values may be expected to decrease as the number paths stochastically increases. Therefore, the present invention proposes a scheme of achieving diversity gain by transmitting the PRSs distinguished by the cyclic delays through different antenna ports based on the terminal in the NLOS environment.

In this instance, the base station may configure independent PRS-Info for each cyclic delay value and report the PRS-Info to the terminal, and the terminal may independently obtain a cross-correlation for each PRS-Info. Alternatively, the base station may inform the terminal of information about PRSs in a form of single PRS-Info, and provide antenna port information for each PRS. In other words, the base station may add antenna port information to the PRS-Info, and configure a cyclic delay value for each antenna port. In this instance, the base station may differently apply precoding to the different antenna ports and transmit the PRSs.

Operations (2.1) and (2.2) may be combined. For example, cyclic delay values may be divided into groups such that PRSs having the same cyclic delay value in a single group may be transmitted through the same antenna port and PRSs having cyclic delay values in different groups may be transmitted through different antenna ports. In this case, the base station may configure cyclic delay values corresponding to one group of the cyclic delay values to be included in single PRS-Info for the terminal.

(3) Reference PRS Muting Information

A specific example of the present invention proposes a scheme in which, when a plurality of PRSs is transmitted in the same frequency resource and cross-correlations corresponding to the respective PRSs are distinguished by applying cyclic delays based on the same PRS sequence according to the above operation (1.1), and when independent PRS-Info is configured for each PRS having a different cyclic delay, particular PRS-Info is configured as reference PRS-Info for PRS muting information, and PRS-Info other than the reference PRS-Info is configured to correspond to PRS muting information of the reference PRS-Info.

When cross-correlations corresponding to the respective PRSs are distinguished by applying cyclic delays according to an operation of the present invention, the PRSs share the same frequency resource. Thus, it is preferable to similarly apply PRS muting based on PRS collision, etc. from an adjacent cell. For example, when a base station having a PCI=0 transmits a PRS as in FIG. 7, if a 0th PRS transmitted by the PCI=0 experiences interference by colliding with another PRS transmitted by a PCI=1, a first PRS transmitted by the PCI=0 is likely to experience interference by a PRS transmitted by the PCI=1. Therefore, the present invention proposes a scheme in which, even when independent PRS-Info is configured for a PRS having a different cyclic delay, particular PRS-Info is configured as reference PRS-Info such that another PRS-Info corresponds to PRS muting information of the reference PRS-Info.

(4) Expected RSTD

A specific example of the present invention proposes a scheme in which, when cross-correlations corresponding to respective PRSs are distinguished by applying cyclic delays to the same PRS sequence according to the above operation (1.1), and the PRSs are transmitted in the same frequency resource, independent expectedRSTD and expectedRSTD-Uncertainty are configured for each cyclic delay.

As shown in FIG. 7, PRSs having different cyclic delays according to an operation of the present invention are characterized in that intervals in which cross-correlations are generated are distinguished from each other. Therefore, when the characteristic is taken into consideration, a base station needs to configure independent expectedRSTD and expectedRSTD-Uncertainty for each cyclic delay for a terminal. However, in LTE Rel-9, expectedRSTD and expectedRSTD-Uncertainty are configured as one value for each cell identified by a PCI and transmitted. Thus, in order to apply an independent value to each cyclic delay, offset values for expectedRSTD and expectedRSTD-Uncertainty may be configured for each cyclic delay in the PRS-Info.

[Operation of Terminal]

(5) Basic Operation

Hereinafter, the present invention basically presumes an operation in which a terminal receives a PRS transmitted from each base station through a radio channel, measures a cross-correlation between the received signal and a PRS sequence transmitted by the base station, measures a period of time at which a correlation value has a certain threshold or more or a maximum value from a reference point in time to estimate a TOA value of each base station, and estimates a TDOA value of each base station to be a value obtained by subtracting a TOA value of a reference base station among base stations from a TOA value of the corresponding base station.

(6) Scheme of Distinguishing a Cross-Correlation for each PRS Distinguished by a Cyclic Delay

(5.1) When Operation (1.2) is not Supported

A specific example of the present invention proposes a scheme in which, when cross-correlations corresponding to respective PRSs are distinguished by applying cyclic delays to the same sequence according to the above operation (1.1), and the PRSs are transmitted in the same frequency resource, a terminal estimates a primary TDOA value using the above operation (5), and then estimates a final TDOA value by performing a modulo operation on the primary TDOA value with respect to an interval between cyclic delays on the assumption that a base station transmits the PRSs by setting a constant interval between cyclic delays (e.g., dₚ=N₀/P).

For example, it is presumed that a reference base station transmitting a reference PRS is referred to as base station #0, and a base station transmitting a PRS corresponding to a target of estimation of a TDOA is referred to as a base station #1. In addition, it is presumed that each base station transmits PRSs having two cyclic delays as in FIG. 11. In this instance, as illustrated in FIG. 11, when a TOA value is deduced from a cross-correlation value corresponding to a 0th PRS for the base station #0, and a TOA value is deduced from a cross-correlation value corresponding to a first PRS for the base station #1, a TDOA value includes an offset corresponding to an interval of cyclic delays. However, when it can be presumed that the interval between cyclic delays is constant, and the TDOA value is smaller than a cyclic delay value, the terminal may obtain a TDOA value from which an estimation error due to the cyclic delays is removed by performing a modulo operation on the TDOA value estimated by operation (5) with respect to the interval between cyclic delays.

(5.2) When Operation (1.2) is Supported

A specific example of the present invention proposes a scheme in which, when cross-correlations corresponding to respective PRSs are distinguished by applying cyclic delays based on the same PRS sequence according to the above operation (1.1), and the PRSs are transmitted in the same frequency resource, and when a series of phase values varying according to time resources is applied to the respective PRSs distinguished by the cyclic delays to repeatedly transmit the PRSs in L time resources according to the above operation (1.2), a terminal receives PRSs transmitted from a base station to estimate a cross-correlation value between the received signal and a PRS sequence based on an interval between the L time resources, and compares sums of absolute values of differences between the L cross-correlation phase values (e.g., θ(l), l=0, 1, . . . , L−1) and a series of phase values according to the above operation (1.2) (e.g., φₚ(l), l=0, 1, . . . , L−1) to distinguish a PRS that causes generation of the cross-correlation from a total of P PRSs.

Specifically, the above comparison process may correspond to an operation of fining a value of p at which a norm value (=Σ_{L}|φₚ(l)−θ(l)|²) is the smallest. The example of FIG. 8 shows that, while a phase difference of 0 degrees is given when a cross-correlation value for a 0th PRS is extracted at an interval of one OFDM symbol, a phase difference of 180 degrees is given when a cross-correlation value for a first PRS is extracted at an interval of one OFDM symbol. Therefore, in the above example, the terminal may extract a cross-correlation for a received signal at an interval of one OFDM symbol, and determine that the extracted cross-correlation is a cross-correlation corresponding to the 0th PRS when a phase difference is close to 0 degrees and is a cross-correlation corresponding to the first PRS when the phase difference is close to 180 degrees.

(6) Feedback of Whether to Support a PRS Distinguished by a Cyclic Delay

According to a specific example of the present invention, when a base station desires to transmit a plurality of PRSs in the same frequency resource and cross-correlations corresponding to the respective PRSs are distinguished by applying cyclic delays based on the same sequence according to operation (1.1), the base station may request information about whether to support the PRSs distinguished by the cyclic delays from a terminal. Specifically, the base station may report a particular cyclic delay interval to the terminal in advance, and the terminal may feed information about whether a maximum delay spread of a channel is smaller than the cyclic delay interval back to the base station according to a channel environment thereof. The above scheme of distinguishing PRSs by applying cyclic delays proposed in the present invention is preferably applied when a maximum delay spread of a channel between the base station and the terminal is sufficiently small, and thus most significant cross-correlation values are present in an interval between cyclic delays. Otherwise, even when different cyclic delays are provided, a cross-correlation between PRSs may not be distinguished. In addition, mutual interference is caused, and thus performance of estimating a TDOA value may be degraded.

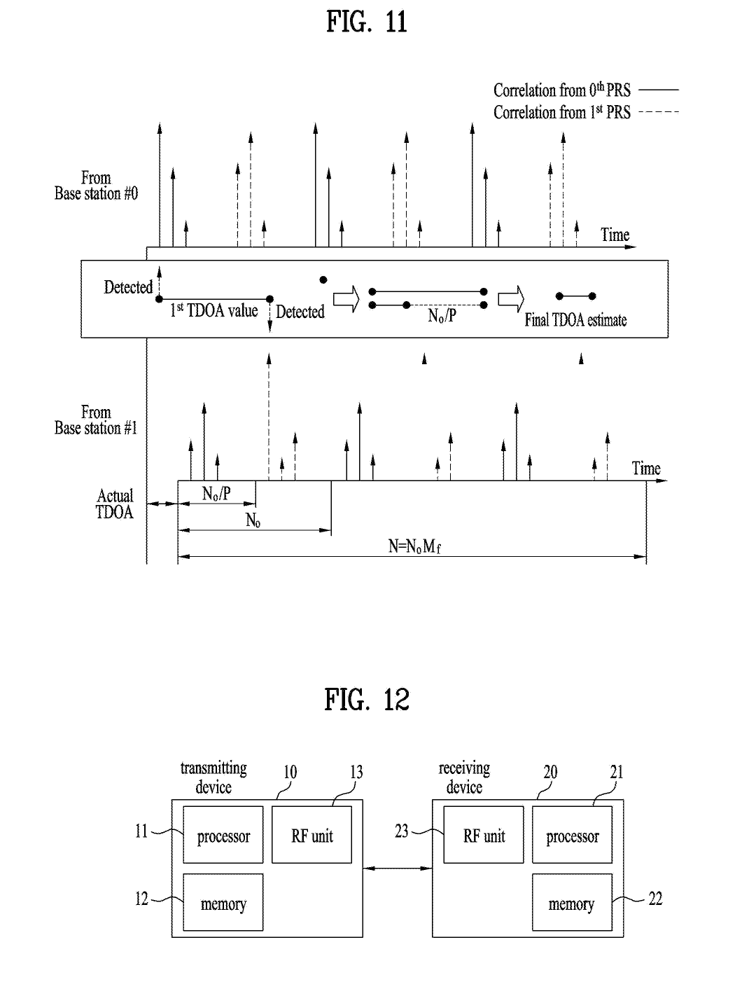

FIG. 12 is a block diagram of a transmitting device 10 and a receiving device 20 configured to implement exemplary embodiments of the present invention. Referring to FIG. 12, the transmitting device 10 and the receiving device 20 respectively include radio frequency (RF) units 13 and 23 for transmitting and receiving radio signals carrying information, data, signals, and/or messages, memories 12 and 22 for storing information related to communication in a wireless communication system, and processors 11 and 21 connected operationally to the RF units 13 and 23 and the memories 12 and 22 and configured to control the memories 12 and 22 and/or the RF units 13 and 23 so as to perform at least one of the above-described embodiments of the present invention.

The memories 12 and 22 may store programs for processing and control of the processors 11 and 21 and may temporarily storing input/output information. The memories 12 and 22 may be used as buffers. The processors 11 and 21 control the overall operation of various modules in the transmitting device 10 or the receiving device 20. The processors 11 and 21 may perform various control functions to implement the present invention. The processors 11 and 21 may be controllers, microcontrollers, microprocessors, or microcomputers. The processors 11 and 21 may be implemented by hardware, firmware, software, or a combination thereof. In a hardware configuration, Application Specific Integrated Circuits (ASICs), Digital Signal Processors (DSPs), Digital Signal Processing Devices (DSPDs), Programmable Logic Devices (PLDs), or Field Programmable Gate Arrays (FPGAs) may be included in the processors 11 and 21. If the present invention is implemented using firmware or software, firmware or software may be configured to include modules, procedures, functions, etc. performing the functions or operations of the present invention. Firmware or software configured to perform the present invention may be included in the processors 11 and 21 or stored in the memories 12 and 22 so as to be driven by the processors 11 and 21.

The processor 11 of the transmitting device 10 is scheduled from the processor 11 or a scheduler connected to the processor 11 and codes and modulates signals and/or data to be transmitted to the outside. The coded and modulated signals and/or data are transmitted to the RF unit 13. For example, the processor 11 converts a data stream to be transmitted into K layers through demultiplexing, channel coding, scrambling and modulation. The coded data stream is also referred to as a codeword and is equivalent to a transport block which is a data block provided by a MAC layer. One transport block (TB) is coded into one codeword and each codeword is transmitted to the receiving device in the form of one or more layers. For frequency up-conversion, the RF unit 13 may include an oscillator. The RF unit 13 may include Nt (where Nt is a positive integer) transmit antennas.

A signal processing process of the receiving device 20 is the reverse of the signal processing process of the transmitting device 10. Under the control of the processor 21, the RF unit 23 of the receiving device 10 receives RF signals transmitted by the transmitting device 10. The RF unit 23 may include Nr receive antennas and frequency down-converts each signal received through receive antennas into a baseband signal. The RF unit 23 may include an oscillator for frequency down-conversion. The processor 21 decodes and demodulates the radio signals received through the receive antennas and restores data that the transmitting device 10 wishes to transmit.

The RF units 13 and 23 include one or more antennas. An antenna performs a function of transmitting signals processed by the RF units 13 and 23 to the exterior or receiving radio signals from the exterior to transfer the radio signals to the RF units 13 and 23. The antenna may also be called an antenna port. Each antenna may correspond to one physical antenna or may be configured by a combination of more than one physical antenna element. A signal transmitted through each antenna cannot be decomposed by the receiving device 20. A reference signal (RS) transmitted through an antenna defines the corresponding antenna viewed from the receiving device 20 and enables the receiving device 20 to perform channel estimation for the antenna, irrespective of whether a channel is a single RF channel from one physical antenna or a composite channel from a plurality of physical antenna elements including the antenna. That is, an antenna is defined such that a channel transmitting a symbol on the antenna may be derived from the channel transmitting another symbol on the same antenna. An RF unit supporting a MIMO function of transmitting and receiving data using a plurality of antennas may be connected to two or more antennas.

The transmitting device and/or the receiving device may be configured as a combination of one or more embodiments of the present invention.

According to an embodiment of the present invention, it is possible to efficiently receive and measure a reference signal in a wireless communication system.

Effects that may be obtained from the present invention are not limited to the above-mentioned effects, and other effects not mentioned herein may be clearly understood by those skilled in the art from the above description.

The embodiments of the present application has been illustrated based on a wireless communication system, specifically 3GPP LTE (-A), however, the embodiments of the present application can be applied to any wireless communication system in which interferences exist.

According an embodiment of the present invention, accuracy of position estimation can be improved.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method for receiving a reference signal for determining a position in a wireless communication system performed by a terminal, the method comprising:
receiving, from a serving base station, cyclic delay information of a plurality of positioning reference signals (PRSs);
receiving the plurality of PRSs from a plurality of base stations using the cyclic delay information, each of the plurality of PRSs being repeatedly received a predetermined number of times for a predetermined period of time, and a respective one of the repeatedly received PRSs having different cyclic delay values with an interval;
calculating a cross-correlation value of each of the plurality of received PRSs; and
calculating a time difference of arrival (TDOA) value of each base station based on the cross-correlation value and reporting the calculated TDOA value to the serving base station.

2. The method according to claim 1, wherein each of the plurality of PRSs have phase values which varies by predetermined time unit.

3. The method according to claim 2, wherein the phase values are represented by phase sequences including complex values, and the phase sequences for the plurality of PRSs are orthogonal to each other.

4. The method according to claim 1, wherein the plurality of PRSs are transmitted through one antenna port of a base station.

5. The method according to claim 1, wherein the plurality of PRSs are transmitted through a plurality of antenna ports of a base station.

6. The method according to claim 1, wherein the TDOA value of each base station is acquired by performing a modulo operation on a difference value between a TOA of a reference base station and a TOA of a corresponding base station with respect to a value of the interval.

7. The method according to claim 2, further comprising
identifying the plurality of PRSs by comparing a phase value of the cross-correlation value with the phase values varying by the predetermined time unit.

8. The method according to claim 1, further comprising
reporting, to the serving base station, information about whether a maximum delay spread of a downlink channel is smaller than the interval.

9. A terminal configured to receive a reference signal for determining a position in a wireless communication system, comprising:
a radio frequency (RF) unit; and
a processor configured to control the RF unit,
wherein the processor is configured to receive, from a serving base station, cyclic delay information of a plurality of PRSs, receive the plurality of PRSs from a plurality of base stations using the cyclic delay information, each of the plurality of PRSs being repeatedly received a predetermined number of times for a predetermined period of time, and a respective one of the repeatedly received PRSs having different cyclic delay values with an interval, calculate a cross-correlation value of each of the plurality of received PRSs, and calculate a a time difference of arrival (TDOA) value of each base station based on the cross-correlation value and report the calculated TDOA value to the serving base station.

10. The terminal according to claim 9, wherein each of the plurality of PRSs have phase values which varies by predetermined time unit.

11. The terminal according to claim 10, wherein the phase values are represented by phase sequences including complex values, and the phase sequences for the plurality of PRSs are orthogonal to each other.

12. The terminal according to claim 9, wherein the plurality of PRSs are transmitted through one antenna port of a base station.

13. The terminal according to claim 9, wherein the plurality of PRSs are transmitted through a plurality of antenna ports of a base station.

14. The terminal according to claim 9, wherein the TDOA value of each base station is acquired by performing a modulo operation on a difference value between a TOA of a reference base station and a TOA of a corresponding base station with respect to a value of the interval.

15. The terminal according to claim 10, wherein the processor is further configured to identify the plurality of PRSs by comparing a phase value of the cross-correlation value with the phase values varying by the predetermined time unit.

16. The terminal according to claim 9, wherein the processor is further configured to report, to the serving base station, information about whether a maximum delay spread of a downlink channel is smaller than the interval.
